(19) United States
(12) Patent Application Publication
(10) Pub. No.: US 2014/0366733 A1
(43) Pub. Date: Dec. 18, 2014

(54) FILTER MEDIA AND METHOD OF FORMING THE SAME

(71) Applicant: BHA Altair, LLC, Franklin, TN (US)

(72) Inventors: Cynthia Marie Polizzi, Delmar, NY (US); Vishal Bansal, Overland Park, KS (US)

(73) Assignee: BHA Altair, LLC, Franklin, TN (US)

(21) Appl. No.: 13/920,129

(22) Filed: Jun. 18, 2013

(51) Int. Cl. B01D 39/16; B01D 71/36; B01D 69/12

(52) U.S. Cl. CPC B01D 39/1623; B01D 69/12; B01D 71/36
USPC 96/13; 96/12; 55/528; 156/62.2

(57) ABSTRACT

A composite filter media is provided. The composite filter media includes a porous membrane material and a nonwoven felt material laminated to the porous membrane material. The nonwoven felt material includes an amount of amorphous fibers and an amount of crystalline fibers, and the amorphous fibers and the crystalline fibers are each fabricated from the same material.

### BACKGROUND OF THE INVENTION

The field of the present disclosure relates generally to filter media and, more specifically, to high-temperature filter media fabricated from a polymeric material.

At least some known power generation systems include a furnace and/or a boiler that generates steam used in a steam turbine generator. During a typical combustion process, a flow of combustion gas or flue gas produced within a combustor, a furnace, and/or a boiler and channeled for use in the steam turbine generator. Known combustion gases contain combustion products such as, but not limited to, carbon, fly ash, carbon dioxide, carbon monoxide, water, hydrogen, nitrogen, sulfur, chlorine, arsenic, selenium, and/or mercury.

One known method of reducing combustion products in a flue gas stream requires channeling the combustion gas through a particulate collection device, such as a baghouse. At least some known baghouses include a housing that has an inlet that receives dirty, particulate-containing air, and an outlet through which clean air is discharged from the baghouse. In known baghouses, a tube sheet divides the interior of the housing into an upstream, dirty air plenum, and a downstream, clean air plenum. Air flows through the inlet into the dirty air plenum, through a plurality of filters, and into the clean air plenum before the clean air is discharged through the outlet of the housing. Known tube sheets are formed with a plurality of apertures that couple the dirty air plenum in flow communication with the clean air plenum through the filters. More specifically, each filter element is coupled about a respective aperture formed in the tube sheet such that at least a portion of the filter element extends through the aperture.

At least some known filters are fabricated by laminating a nonwoven felt material to a microporous membrane to form a composite filter media, that is then formed into a desired configuration. Laminating the nonwoven felt material to the microporous membrane is at least partially dependent on a melting point of the polymeric fibers used to fabricate the nonwoven felt material. For example, nonwoven filter media may be fabricated from semi-crystalline polymeric fibers of a base polymer material. The base polymer material is generally selected based on the thermal, mechanical, and/or chemical resistance properties of the material. However, thermally laminating the nonwoven felt material at temperatures that facilitate melting the semi-crystalline base polymeric fibers may affect the properties of the base polymer material.

One known method of laminating the nonwoven felt material to the microporous membrane includes adding a secondary polymer having a lower melting point than the base polymer material to the fibers of the base polymer material. The secondary polymer may be added by blending polymeric fibers of the secondary material with the fibers of the base polymer material when forming the nonwoven felt material, co-extruding the base polymer material and the secondary polymer material to form sheath-core bicomponent fibers, and/or treating a nonwoven felt material fabricated from the base polymer material with a dispersion of lower melting point thermoplastic material. However, forming the nonwoven felt material from a base polymer material and a secondary polymer material may produce a nonwoven felt material having mechanical, thermal, and/or chemical resistance properties that may be dictated by the secondary polymer material.

### BRIEF DESCRIPTION OF THE INVENTION

In one aspect, a composite filter media is provided. The composite filter media includes a porous membrane material and a nonwoven felt material laminated to the porous membrane material. The nonwoven felt material includes an amount of amorphous fibers and an amount of crystalline fibers, and the amorphous fibers and the crystalline fibers are each fabricated from the same material.

In another aspect, a filter media is provided. The filter media includes a nonwoven felt material including an amount of amorphous fibers and an amount of crystalline fibers. The amorphous fibers and the crystalline fibers are each fabricated from the same material, and the nonwoven felt material is configured to filter particles entrained in a fluid flow.

In yet another aspect, a method of forming a filter media is provided. The method includes forming a nonwoven felt material from an amount of amorphous fibers and an amount of crystalline fibers, wherein the amorphous fibers and the crystalline fibers are each fabricated from the same material. The method also includes laminating the nonwoven felt material to a porous membrane material at a temperature that is above a glass transition temperature of the amorphous fibers and below a melting point of the crystalline fibers.

### BRIEF DESCRIPTION OF THE DRAWINGS

FIG. 1 is a schematic illustration of an exemplary baghouse.

FIG. 2 is a schematic sectional illustration of an exemplary filter media that may be used in the baghouse shown in FIG. 1.

FIG. 3 is a schematic sectional illustration of an exemplary composite filter media that may be used in the baghouse shown in FIG. 1.

### DETAILED DESCRIPTION OF THE INVENTION

Embodiments of the present disclosure relate to a filter media that includes a nonwoven felt material fabricated from a single polymeric material. More specifically, the nonwoven felt material is formed from thermoplastic polymeric fibers of the same polymeric material that have varying levels of crystallinity. In the exemplary embodiment, the nonwoven felt material is formed from an amount of amorphous fibers and an amount of crystalline fibers. By blending the amorphous fibers and the crystalline fibers, the mechanical properties of the resulting material enable the nonwoven felt material to be used in high-temperature, particulate air filtration assemblies. Further, in some embodiments, the nonwoven felt material produced may be laminated to a microporous membrane to form a composite filter media. Blending the amorphous fibers with the crystalline fibers enables laminating the nonwoven felt material to the microporous membrane by exploiting a glass transition temperature of the amorphous fibers that is lower than a melting point of the crystalline fibers. As such, the filter media may be laminated to a microporous membrane without the use of a secondary material, and thus may have improved mechanical, thermal, and/or chemical resistance properties over known filter media.

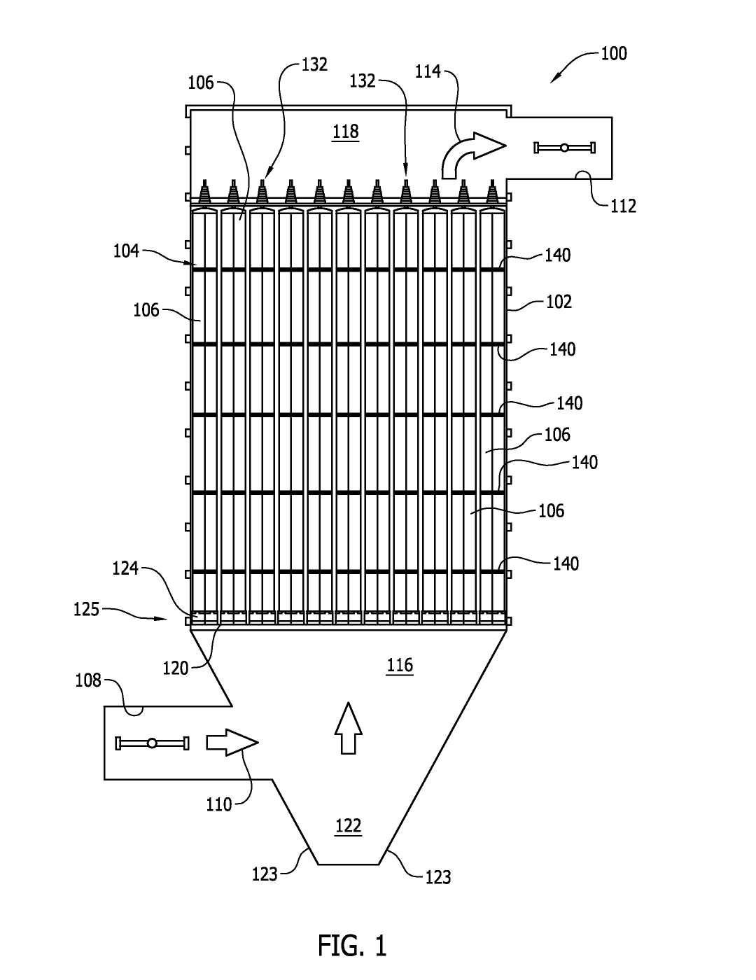

FIG. 1 is a schematic illustration of an exemplary baghouse 100. In the exemplary embodiment, baghouse 100 includes a housing 102 and a plurality of filter assemblies 104 within housing 102. Each filter assembly 104 includes a filter bag 106. Although filter bag 106 as illustrated has a circular cross-section, it should be apparent to one of ordinary skill in the art, that the filter element may have other suitable cross-sectional profiles, such as an elliptical or rectangular cross-sectional profile. Further, it should be understood that filter assemblies 104 may be arranged in a vertically-extending matrix in a typical housing 102 as is known in the baghouse industry. Baghouse 100 also includes an inlet 108 that is oriented to receive a stream of particulate-laden gas 110 and an outlet 112 that enables a stream of cleaned gas 114 to be discharged from baghouse 100. In an alternative embodiment, baghouse 100 may be a pulse-jet baghouse.

Housing 102 is divided into a first plenum 116 and a second plenum 118 by a cell plate 120. Cell plate 120 may be fabricated from any suitable material, such as a metal plate or sheet. Inlet 108 is positioned in flow communication with first plenum 116, and outlet 112 is positioned in flow communication with second plenum 118. In the exemplary embodiment, an accumulation chamber 122 at a lower end of first plenum 116 is defined by sloped walls 123. More specifically, in the exemplary embodiment, accumulation chamber 122 has a V-shaped cross-sectional profile. In one embodiment, a baffle (not shown) is included within first plenum 116. Cellplate 120 may include thimbles (not shown) that extend from cellplate 120 for use in coupling cellplate 120 to filter bag 106. In an alternative embodiment, baghouse 100 may also include a reverse flow sub-system (not shown) to facilitate removing dust or other particulate matter from filter bag 106. The reverse flow sub-system may include a fan (not shown), wherein the size of the fan is selected based on a fixed volume of air within baghouse 100.

In the exemplary embodiment, a plurality of filter assemblies 104 are suspended from a tensioning assembly 132. More specifically, in the exemplary embodiment, each filter assembly 104 is supported at a closed end 125 of each filter bag 106 via a support structure 124. In the exemplary embodiment, each filter assembly 104 hangs from a tensioning assembly 132. Further, in the exemplary embodiment, filter bag 106 includes at least one anti-collapse ring 140 that maintains filter bag 106 in an open position during a reverse air cleaning process. Anti-collapse ring 140 may be formed from a metal material.

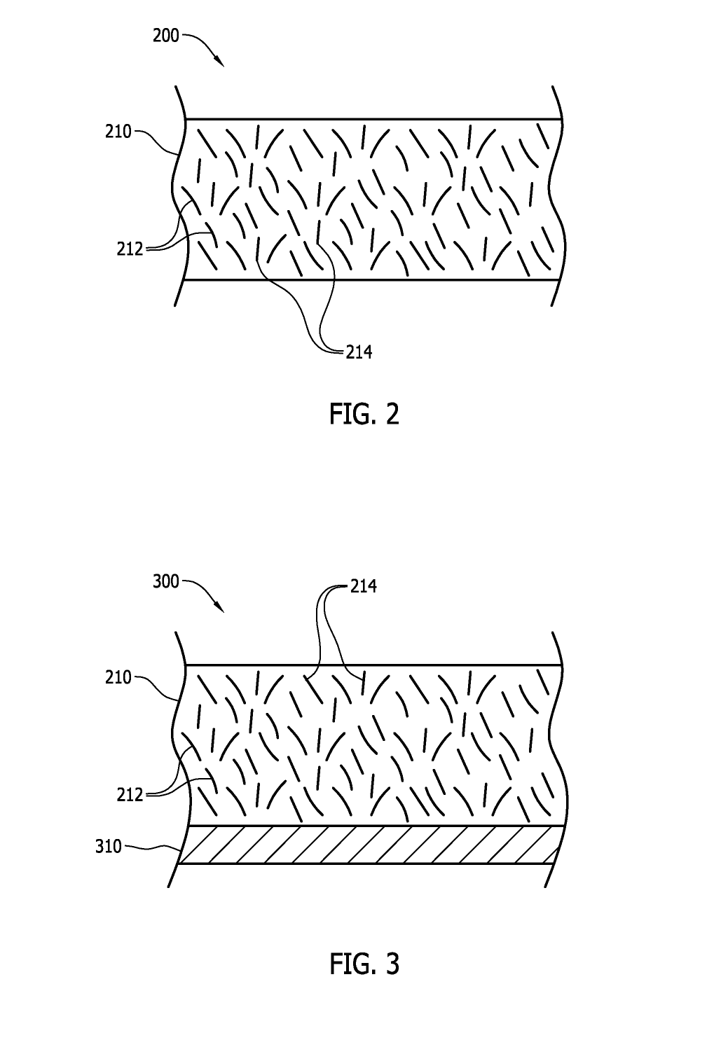

FIG. 2 is a schematic sectional illustration of an exemplary filter media 200. In the exemplary embodiment, filter media 200 includes a nonwoven felt material 210 that is fabricated from an amount of amorphous fibers 212 and an amount of crystalline fibers 214. Polymer crystallinity may be measured using Differential Scanning calorimetry (DSC). As used herein, the term “amorphous” refers to fibers having a degree of crystallinity that is less than about 20 percent by weight of an amount of fibers, and the term “crystalline” refers to fibers having a degree of crystallinity that is greater than about 20 percent by weight of an amount of fibers.

In the exemplary embodiment, amorphous fibers 212 and crystalline fibers 214 are each fabricated from the same polymeric material. Fibers 212 and 214 may be fabricated from any thermoplastic, polymeric material that enables filter media 200 to function as described herein. For example, fibers 212 and 214 may be fabricated from any thermoplastic, polymeric material that is capable of withstanding temperatures of at least about 200° C. Exemplary materials that may be used to fabricate fibers 212 and 214 include, but are not limited to, a polypropylene material, a polyester material, a polyphenylene sulfide (PPS) material, a polytetrafluoroethylene (PTFE) material, a nylon material, an aramid material, a polyarylene sulfide material, a polyimide material, a polyamide material, a polyetherimide material, and a polyamideimide material.

In some embodiments, nonwoven felt material 210 includes any concentration of amorphous fibers 212 that enables filter media 200 to function as described herein. For example, in one embodiment, nonwoven felt material 210 includes less than about 40 percent amorphous fibers 212 by weight of nonwoven felt material 210 and, more specifically, between about 15 percent and about 20 percent amorphous fibers 212 by weight of nonwoven felt material 210. Further, amorphous fibers 212 and crystalline fibers 214 may have any degree of crystallinity that enables filter media 200 to function as described herein. In one embodiment, amorphous fibers 212 have at least about a 30 percent lower degree of crystallinity than crystalline fibers 214. Further, in some embodiments, crystalline fibers 214 have a linear mass density defined within a range between about 2 denier per filament and about 4 denier per filament.

In some embodiments, the amount of amorphous fibers 212 may facilitate improving the mechanical, thermal, and/or chemical resistance properties of filter media 200 when compared to a filter media fabricated from crystalline fibers and a secondary polymer material. For example, increasing an amount of amorphous fibers 212 within nonwoven felt material 210 may facilitate increasing a density of nonwoven felt material 210. As such, increasing the concentration of amorphous fibers 212 within nonwoven felt material 210 may facilitate improving the fatigue life of filter media 200, and may enable nonwoven felt material 210 to be fabricated without the use of a stiffening binder. Further, fabricating nonwoven felt material 210 from a single polymeric material enables nonwoven felt material 210 to retain its thermal and/or chemical resistance properties without being affected by the properties of a secondary polymer material.

Nonwoven felt material 210 has a basis weight of from about 9 ounces per square yard (oz/yd²) (306.1 g/m²) to about 20 oz/yd² (680.3 g/m²), and a thickness of from about 0.040 inch (1.02 millimeters (mm)) to about 0.100 inch (2.54 mm). In an alternative embodiment, nonwoven felt material 210 may have any basis weight and/or thickness that enables nonwoven felt material 210 and/or filter media 200 to function as described herein.

FIG. 3 is a schematic sectional illustration of an exemplary composite filter media 300. In the exemplary embodiment, filter media 300 includes a porous membrane material 310 and nonwoven felt material 210 coupled to porous membrane material 310. More specifically, in the exemplary embodiment, nonwoven felt material 210 is laminated to porous membrane material 310. Nonwoven felt material 210 also includes an amount of amorphous fibers 212 and an amount of crystalline fibers 214 that are each fabricated from the same material.

Porous membrane material 310 may be fabricated from any material that enables composite filter media 300 to function as described herein. For example, porous membrane material 310 may be fabricated from any material that facilitates improving the filtration efficiency of composite filter media 300, and that enables collected airborne particles (not shown) to be removed from composite filter media 300 during cleaning operations. An exemplary material that may be used to fabricate porous membrane material 310 includes, but is not limited to, expanded-polytetrafluoroethylene (ePTFE).

In the exemplary embodiment, amorphous fibers 212 facilitate laminating nonwoven felt material 210 to porous membrane material 310. Generally, a material that is in an amorphous state has a lower glass transition temperature than a melting point of the same material in a crystalline state. Accordingly, amorphous fibers 212 have a glass transition temperature that is lower than a melting point of crystalline fibers 214. In the exemplary embodiment, nonwoven felt material 210 is laminated to porous membrane material 310 at a predetermined temperature that is above the glass transition temperature of amorphous fibers 212 and below the melting point of crystalline fibers 214. Laminating nonwoven felt material 210 at the predetermined temperature facilitates softening amorphous fibers 212, and nonwoven felt material 210 couples to porous membrane material 310 as a temperature of composite filter media 300 decreases and amorphous fibers 212 harden. In some embodiments, the predetermined temperature is about halfway between the glass transition temperature of amorphous fibers 212 and the melting point of crystalline fibers 214.

A method of forming a filter media, such as composite filter media 300 is also described herein. The method includes forming a nonwoven felt material, such as nonwoven felt material 210, from an amount of amorphous fibers and an amount of crystalline fibers, such as amorphous fibers 212 and crystalline fibers 214. In some embodiments, the nonwoven felt material is formed by interlocking the amorphous fibers and the crystalline fibers in a needlepunch process. For example, continuous and/or discontinuous amorphous and crystalline fibers may be laid down on a moving belt (not shown) and a plurality of needles (not shown) may entangle the fibers to form the nonwoven felt material. When entangling discontinuous amorphous and crystalline fibers, each may have a length between about 2 inches and about 4 inches. Accordingly, the amorphous fibers and the crystalline fibers may be substantially evenly distributed within the nonwoven felt material. The nonwoven felt material may then be laminated to a porous membrane material, such as porous membrane material 310. Further, in some embodiments, the method may include pleating the filter media and/or the nonwoven felt material.

The filter media described herein includes a nonwoven felt material that is fabricated from a single polymeric material. More specifically, the nonwoven felt material is formed from an amount of amorphous fibers and an amount of crystalline fibers that are each fabricated from the same polymeric material. Further, the composition of the nonwoven felt material enables it to be laminated to a substrate without the use of a secondary polymer and/or dispersion. More specifically, the nonwoven felt material may be heated to a predetermined temperature to soften the amorphous fibers, and the nonwoven felt material may laminate to the substrate as the amorphous fibers harden. As such, omitting the lower melting point secondary material from the filter media described herein facilitates improving the mechanical, thermal, and/or chemical resistance properties of the filter media.

This written description uses examples to disclose the embodiments of the present disclosure, including the best mode, and also to enable any person skilled in the art to practice the embodiments, including making and using any devices or systems and performing any incorporated methods. The patentable scope of the embodiments are defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A composite filter media comprising:
a porous membrane material; and
a nonwoven felt material laminated to said porous membrane material, said nonwoven felt material comprising an amount of amorphous fibers and an amount of crystalline fibers, wherein the amorphous fibers and the crystalline fibers are each fabricated from the same material.

2. The filter media in accordance with claim 1, wherein the amorphous fibers have a glass transition temperature that is lower than a melting point of the crystalline fibers.

3. The filter media in accordance with claim 1, wherein said nonwoven felt material comprises less than about 40 percent of the amorphous fibers by weight of said nonwoven felt material.

4. The filter media in accordance with claim 3, wherein said nonwoven felt material comprises between about 15 percent and about 20 percent of the amorphous fibers by weight of said nonwoven felt material.

5. The filter media in accordance with claim 1, wherein the material comprises one of at least a polypropylene material, a polyester material, a polyphenylene sulfide (PPS) material, a polytetrafluoroethylene (PTFE) material, a nylon material, an aramid material, a polyarylene sulfide material, a polyimide material, a polyamide material, a polyetherimide material, and a polyamideimide material.

6. The filter media in accordance with claim 1, wherein the amorphous fibers have at least about a 30 percent lower degree of crystallinity than the crystalline fibers.

7. The filter media in accordance with claim 1, wherein said porous membrane material is fabricated from an expanded-polytetrafluoroethylene (ePTFE) material.

8. A filter media comprising:
a nonwoven felt material comprising an amount of amorphous fibers and an amount of crystalline fibers, wherein the amorphous fibers and the crystalline fibers are each fabricated from the same material, said nonwoven felt material configured to filter particles entrained in a fluid flow.

9. The filter media in accordance with claim 8, wherein the amorphous fibers and the crystalline fibers are interlocked within a volume of said nonwoven felt material.

10. The filter media in accordance with claim 8, wherein the amorphous fibers and the crystalline fibers are at least one of continuous fibers and discontinuous fibers.

11. The filter media in accordance with claim 8, wherein said nonwoven felt material does not comprise a stiffening binder.

12. The filter media in accordance with claim 8, wherein the amorphous fibers and the crystalline fibers are substantially evenly distributed within said nonwoven felt material.

13. The filter media in accordance with claim 8, wherein increasing the amount of the amorphous fibers within said nonwoven felt material facilitates increasing a density of said nonwoven felt material.

14. The filter media in accordance with claim 8, wherein the crystalline fibers have a linear mass density defined within a range between about 2 denier per filament and about 4 denier per filament.

15. A method of forming a filter media, said method comprising:
forming a nonwoven felt material from an amount of amorphous fibers and an amount of crystalline fibers, wherein the amorphous fibers and the crystalline fibers are each fabricated from the same material; and
laminating the nonwoven felt material to a porous membrane material at a temperature that is above a glass transition temperature of the amorphous fibers and below a melting point of the crystalline fibers.

16. The method in accordance with claim 15, wherein forming a nonwoven felt material comprises interlocking the amorphous fibers and the crystalline fibers in a needlepunch process.

17. The method in accordance with claim 15, wherein forming a nonwoven felt material comprises forming the nonwoven felt material with less than about 40 percent amorphous fibers by weight of the nonwoven felt material.

18. The method in accordance with claim 15, wherein forming a nonwoven felt material comprises selecting amorphous fibers that have at least about a 30 percent lower degree of crystallinity relative to the crystalline fibers.

19. The method in accordance with claim 15, wherein laminating the nonwoven felt material comprises laminating the nonwoven felt material at a temperature that is about halfway between the glass transition temperature of the amorphous fibers and the melting point of the crystalline fibers.

20. The method in accordance with claim 15 further comprising pleating the filter media.
